(19) United States
(12) Patent Application Publication
(10) Pub. No.: US 2026/0348528 A1
(43) Pub. Date: Nov. 5, 2026

(54) Tank for storing hydrogen in solid form and method of manufacture

(71) Applicant: MINCATEC ENERGY, MEROUX-MOVAL (FR)

(72) Inventor: Yann GENNINASCA, Meroux-Moval (FR)

(73) Assignee: MINCATEC ENERGY, MEROUX-MOVAL (FR)

(21) Appl. No.: 19/535,432

(22) Filed: Feb. 10, 2026

(30) Foreign Application Priority Data
Apr. 30, 2025 (FR) 2504645

(51) Int. Cl. F17C 11/00

(52) U.S. Cl. CPC F17C 11/005; F17C 2201/0104; F17C 2205/0311; F17C 2209/222; F17C 2221/012; F17C 2227/03

(57) ABSTRACT

A hydrogen tank that is compact, safe and of improved energy efficiency includes a hollow cylindrical container for storing a metal hydride and a passive hydrogen diffusion tube. The tank also includes a first cap for closing and sealing the hollow cylindrical container including a peripheral portion with a radial terminal shoulder intended to be welded by friction stir welding to the terminal edge of the hollow cylindrical container. The hollow cylindrical container and the cap are made of aluminium or aluminium alloy.

The invention relates to a tank for storing hydrogen in solid form, in particular in the form of metal hydrides at low pressure, and a method of manufacturing such a tank.

Hydrogen is used in numerous industrial fields, notably as a fuel or as a reactant. In this case, given its volume in the gas state and its explosivity in air, it is desirable for the hydrogen to be stored in a form ensuring a reduced overall size and safe confinement.

Three main technologies exist at present.

The first consists in storing gaseous hydrogen at very high pressure (between 350 bar and 700 bar) to compress it in tanks designed to resist such pressures. This type of storage further necessitates a large quantity of energy to compress the hydrogen and to cool it. The energy balance of the use of hydrogen employing this storage mode is therefore relatively poor and costly. Finally, the tanks designed for these high pressures use materials that cannot be recycled at this time such as carbon fibre.

The second technology consists in storing the hydrogen in liquid form. It is then necessary to maintain a temperature below −252.87 °C to liquefy hydrogen in tanks. This type of storage necessitates a large quantity of energy to maintain the hydrogen in the liquid state.

The third technology consists in storing the gaseous hydrogen in a solid medium in the form of a compacted metal hydride powder.

This technology enables safer storage conditions and a limited energy expenditure. Some metals or alloys can reversibly incorporate atoms of hydrogen in the crystal lattice. The hydrogen is absorbed/desorbed by these materials as a function of temperature and pressure conditions. They are for example palladium (Pd), magnesium (Mg), ZrMn2, Mg2Ni or alloys like Mg—Mg2Ni or alanates.

By convention the term “metal hydride” as used here covers, depending on the step of the method, the metal partially or completely charged with hydrogen.

Two types of metal hydrides are generally distinguished: heavy hydrides (mainly LaNi₅, and alloys such as ferro-titanium alloy, manganese-titanium alloy or the alloy based on Ti—V—Cr) and light hydrides (mainly based on magnesium and lithium).

With heavy hydrides the hydrogen is absorbed at moderate temperature (below 60 °C). The exothermy of the reaction is generally less than or equal to 35 KJ/mol H₂. During use the hydrogen is then also desorbed at a moderate temperature (below 60 °C). The energy input necessary for using hydrogen is therefore reasonable.

With light hydrides the absorption of the hydrogen by the light metal hydride necessitates a higher temperature (approximately 300 °C for MgH₂). This reaction is highly exothermic (75 kJ/mol H₂). The energy input necessary to initiate the reaction of absorption of hydrogen is therefore moderate but desorption of the hydrogen necessitates a high input of heat, the reaction being highly endothermic.

Because of the exothermy/endothermy of absorption/desorption the use of hydrides (irrespective of their type) for the storage/delivery of hydrogen necessitates very effective thermal management to be sure that a satisfactory volume of hydrogen is stored/delivered with a flowrate compatible with the use envisaged.

Furthermore, the absorption/desorption reactions generate swelling/shrinkage of the hydride, that is to say expansion/contraction of the volume of the hydride when charging/discharging hydrogen.

The variation of volume and the thermal variation must therefore be taken into account in producing the tank and filling it with metal hydride, because the mechanical stresses to which the walls of the tank are subjected can lead to cracking, or even to rupture of said tank, leading to a leak that can result in accidents.

The present invention aims to propose a tank for storing hydrogen in solid form that is safe (that is to say with no risk of rupture by the mechanical stresses resulting from variations of volume during absorption/desorption) and offers a fast kinetic of hydrogen absorption/desorption thanks to effective and precise thermal management.

The document FR2939784 describes a hydrogen storage tank using a light metal hydride, in particular magnesium hydride, mixed and compacted with a thermally conductive matrix (notably expanded natural graphite (ENG)) and combined with a system for reversible storage of the heat of absorption. The tank comprises a plurality of tubular containers each delimited by a thermally conductive wall immersed in a container filled with phase-change material.

It is specified that the wall of each container is made of stainless steel. The above document depicts the prerequisite whereby stainless steel is chosen for the manufacture of the tanks in this hydrogen storage application. Indeed, this material is known to offer excellent mechanical strength that enables it to resist the stresses to which it is subjected during swelling of the hydrides. It is also very easy to machine, which makes stainless steel the ideal candidate for the manufacture of hydrogen storage tanks.

However, this ease of machining is notably linked to the fact that stainless steel offers mediocre thermal conduction compared to other materials, which enables the machined structure to withstand mechanically the heat generated by machining. Now this mediocre conductivity has a negative influence on the thermal management of the tanks, which has led to attempts to improve the thermal conduction of the hydride/expanded natural graphite mixture itself, since it was not possible to improve the thermal conduction of stainless steel.

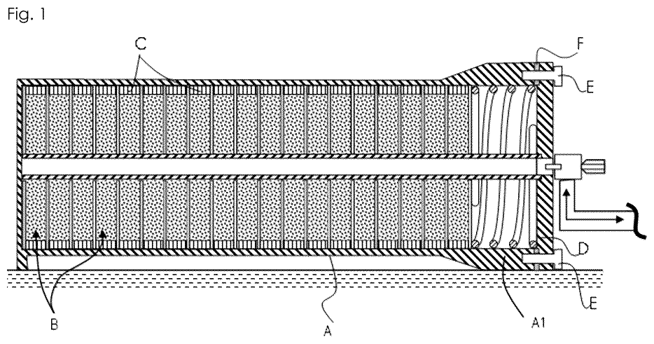

For example the document FR2924787 proposes compacted pellets consisting of a mixture of hydride and expanded natural graphite in a uniaxial direction. Alternatively the document FR3132706 describes a tank A depicted in FIG. 1 as prior art including a passive hydrogen diffusion tube around which are arranged pellets of hydride B surrounded by a ring C of expanded natural graphite enabling better thermal conduction overall and improving the thermal transfer to the lateral walls of the stainless steel tank.

These technological choices for the metal hydride still come up against the mediocre thermal properties of stainless steel, however.

It has already been proposed in the document EP1280730 to change the material constituting the wall of hydrogen tanks to aluminium but the document does not describe any concrete embodiment that is truly susceptible to industrialisation. The tank depicted highly diagrammatically in the document comprises a convex end including a small orifice forming a neck closed by a sealing half-shell welded to the tank. This solution resembles thermoformed aluminium cylinders for the storage of gaseous hydrogen, except that in the document EP1280730 the volume of the cylinder is filled with an aluminium sponge (for thermal conduction) the pores of which are filled with the metal hydride.

This cylinder structure (that is to say with an outlet orifice that is narrower than the tank itself) has numerous drawbacks.

Thus it is not at all polyvalent, because it is limited to the use of hydrides in powder form since it is impossible to insert through the neck compressed hydride pellets with expanded natural graphite. Furthermore, the metal sponge necessarily occupies a large space, which reduces the volume of hydride that can be used. To assure a minimum storage volume the document EP1280730 teaches filling the tank completely with hydride and the metal sponge. Doing this the swelling of the hydrides would generate mechanical stresses that would impact negatively the mechanical strength on cycling of the tank by creating cracks, notably at the level of the weld. Moreover, as the document EP1280730 itself indicates the tank must be of relatively small diameter to enable good thermal management, which further reduces the storage capacity of this type of tank. Finally, it is impossible to use a passive hydrogen diffusion tube since the tank is already filled with the metal sponge saturated with hydride and it is not possible to pass such a tube through the neck before filling the tank without preventing subsequent filling. The hydrogen stored at the bottom of the tank therefore has difficulty in rising toward the neck with the result that the usable storage volume is reduced. This is why this type of tank can at best store only around one hundred grams of hydrogen, which excludes its use for high-capacity storage. In any case this type of tank does not constitute a credible option for the person skilled in the art seeking to create an aluminium tank of large capacity.

Given their respective mechanical properties, it is not possible for the person skilled in the art simply to replace stainless steel with aluminium with the structure of the tanks from the other documents mentioned above.

A first difficulty in using aluminium in hydrogen tanks is linked to its thermomechanical characteristics: its high thermal conductivity, its relatively low melting point, and its sensitivity to oxidation make it difficult to control the welding. In contrast to stainless steel, the narrower melting range of which enables good thermal management of the welding process, aluminium imposes rigorous preparation of the surfaces and strict control of the temperature to prevent irregular, porous or fragile welds. Furthermore the use of aluminium gives rise to specific constraints in terms of mechanical assembly. Aluminium being softer, it withstands badly high clamping forces and mechanical stresses due to swelling/shrinkage of the hydrides. Thus the threads of bolts for fixing a cap conforming to FIG. 1 made of aluminium can be crushed, torn off or degraded as use proceeds, compromising the stability of the assembly and the seal of the tank. This behaviour renders inappropriate the application of high clamping torques, as usually required by stainless steel tanks, in particular under conditions of high internal pressure linked to swelling of the hydrides.

For example the tank from the document FR3132706 depicted in FIG. 1 includes a cap D fixed onto a hollow cylindrical container A by means of bolts E. To this end the edge A1 of the container A has extra thickness to enable the use of bolts of sufficiently large diameter to resist the pressure. The hydrogen seal is assured by forcibly screwing the cap D onto the hollow cylindrical container A, crushing a seal F. However the screwing has to be very tight given the pressures to which the cap may be subjected, as much by the pressure of hydrogen as by the pressure resulting from swelling of the hydride.

Now, aluminium is much softer than stainless steel. Under a high screwing stress the threads could be crushed, torn off or damaged. Furthermore aluminium can deform under a high clamping force, which can lead to less stable assemblies, a loss of torque or a loss of seal.

It is for this reason that aluminium has not been used for the manufacture of high-capacity tanks for storing hydrogen in solid form.

The invention therefore has for object to propose a tank structure enabling the use of aluminium (or aluminium alloy) as the material constituting the tank. It aims more generally to propose a solution to storing hydrogen in the form of metal hydrides enabling the design and the manufacture of modular hydrogen tanks that are safe (that is to say with no risk of rupture of the wall under mechanical stress and with no risk of explosion) and improved energy efficiency (that is to say having in particular an increased charging speed).

The idea behind the invention is to improve the thermal transfer through the wall of the tank by proposing a particular design of the structure of the tank and a particular method of manufacture to enable the use of aluminium or aluminium alloy as the material constituting the wall of the tank, the tank being manufacturable industrially, but also to resist the thermal stress conditions implied by the storage of hydrogen in the form of metal hydride. Furthermore the tank must be perfectly sealed even though it necessitates filling with the metal hydride pellets or powder, implying subsequent sealed closure, separate from the step of manufacturing the elements of the tank.

To this end the invention has more precisely for object a tank for storing hydrogen in solid form, comprising:
a hollow cylindrical container extending along a longitudinal axis, having a first end and a second end, and delimited by a thermally conductive exterior radial wall, the hollow cylindrical container comprising:
   at least one metal hydride for storing hydrogen, and
   a tube for passive diffusion of hydrogen extending axially along the hollow cylindrical container inside the metal hydride and adapted to allow hydrogen to pass through it without allowing metal hydride to pass through it, and
a first cap for closing and sealing the first end of the hollow cylindrical container, the first cap including a hydrogen inlet/outlet orifice fluidically connected to the passive hydrogen diffusion tube, which tank is characterized in that:
the first cap comprises a central portion and a peripheral portion, the latter including:
   a radial terminal shoulder including a free surface opposite a welding surface shaped to be able to be in contact with a first terminal edge of the first end of the hollow cylindrical container,
   an axial shoulder extending axially in the direction of the hollow cylindrical container and including a screwthread intended to cooperate with a screwthread carried by an internal face of the first end of the hollow cylindrical container,
the hollow cylindrical container and the cap are made of the same material, aluminium or aluminium alloy, and
the first cap is welded to the first terminal edge of the hollow cylindrical container by friction stir welding in the peripheral portion of the cap.

Thus the invention proposes a container capable of more effective transfer of heat from and to the metal hydrides with thanks to the use of aluminium as the material constituting the tank and capable of resisting over time hydrogen absorption/desorption cycles thanks to the single screwthread between the hollow cylindrical container and a cap (namely a multitude of screwthreads for bolts) and safe welding between the cap and the hollow cylindrical container by a friction stir welding process carried out through the cap.

In accordance with particular embodiments of the invention:
the interior wall of the hollow cylindrical container can include, under the screwthread carried by the first end, a peripheral rabbet on which bears a disc seal including an opening for the sealed passage of one end of the passive diffusion tube;
the axial shoulder of the cap can have an axial length determined so that in the position of use one end of the axial shoulder of the cap defines with the peripheral rabbet on which the disc seal bears a groove for immobilising the disc seal radially and axially;
the tank can include an intermediate junction part between the disc seal and the end of the passive diffusion tube;
an internal face of the first cap directed toward the interior of the hollow cylindrical container can include a peripheral rabbet on which bears in sealed manner a passive hydrogen diffusion filter adapted to allow hydrogen to pass through it without allowing metal hydride to pass through it, and a peripheral groove for axially and radially fixing an elastic means for holding the passive diffusion filter against the peripheral rabbet;
the storage tank can further include a hollow cylindrical external jacket arranged around the hollow cylindrical container at a distance determined by at least one cylindrical spacer arranged near the first end of the hollow cylindrical container and the cylindrical external jacket in such a manner as to define between the external jacket and the hollow cylindrical container a sealed volume for circulation in use of a heat transfer liquid, the external jacket including an inlet and an outlet for the heat transfer liquid in use. In this case:
the free surface of the radial terminal shoulder is shaped so that it can be in contact with the first terminal edge of the first end of the hollow cylindrical container, a first terminal edge of the cylindrical spacer, and a first terminal edge of the cylindrical external jacket,
the hollow cylindrical container, the cylindrical external jacket, the cylindrical spacer and the cap are made of the same material, aluminium or aluminium alloy, and
the first cap is welded to the first terminal edge of the hollow cylindrical container, to the first terminal edge of the cylindrical spacer and to the first terminal edge of the cylindrical external jacket by friction stir welding (FSW) in the peripheral portion of the cap;
the second end of the hollow cylindrical container can be closed by a wall forming an integral part of said container; in this case, if the tank includes an external jacket the second end of the cylindrical external jacket can also be closed by a wall forming an integral part of said jacket; and/or
the second end of the hollow cylindrical container can have a structure identical to that of the first end of said container and be welded to a second cap in an identical manner to welding said first end to the first cap; in this case, if the tank includes an external jacket the second end of the cylindrical external jacket has a structure identical to that of the first end of said jacket and is welded to said second cap in a manner identical to welding said first end to the first cap.

The invention also has for object a system for storing hydrogen in solid form including:
at least one tank according to any one of claims 6 to 8 for storing hydrogen in solid form,
a circuit for circulating a heat transfer fluid connected on the one hand to the heat transfer liquid inlet and outlet of the external jacket of the or each tank and on the other hand to a heat exchanger adapted to cool/heat the heat transfer fluid, and
a means for circulating the heat transfer fluid in the circuit between the hydrogen storage tank(s) and the heat exchanger.

The invention also has for object a method of manufacturing such a tank for storing hydrogen in solid form, the method comprising the following steps:
a) positioning the hollow cylindrical container so that the first terminal edge of the hollow cylindrical container is ready to receive a cap blank including a radial terminal shoulder,
b) screwing the cover blank into the screwthread at the first end of the cylindrical container,
c) placing the whole in a friction stir welding machine including a mobile welding head with a welding pin and preferably a planishing shoulder,
e) rotating the welding head so that the welding pin penetrates the radial terminal shoulder and moving the welding head radially above the terminal edge of the cylindrical container,
f) moving the welding head around the longitudinal axis to weld the cap and the hollow cylindrical container in a single step, and
h) machining the cap blank to remove welding residues resulting from the passage of the welding head and to obtain the definitive cap.

In one particular embodiment of the foregoing method the radial shoulder can include a sacrificial terminal portion having a radial length such that after being screwed into the hollow cylindrical container it radially overlies the hollow cylindrical container over a particular length. In this case:
the step e) consists in rotating and moving the welding head so that the welding pin penetrates the radial terminal shoulder and is moved radially until the welding pin is located above the terminal edge of the cylindrical container, and
the step h) includes removing the part radially overlying the hollow cylindrical container.

In another embodiment of the invention, when the tank includes an external jacket and a spacer the method comprises the following steps:
a) disposing the hollow cylindrical container in the external jacket and placing the spacer between the cylindrical container and the external jacket so that the first terminal edge of the hollow cylindrical container, the first terminal edge of the cylindrical spacer and the first terminal edge of the external jacket are coplanar,
b) screwing a blank of the cap into the screwthread at the first end of the cylindrical container, the cap blank including a radial terminal shoulder,
c) placing the whole in a friction stir welding machine including a mobile welding head with a welding pin and preferably a planishing shoulder,
e) rotating the welding head so that the welding pin penetrates the radial terminal shoulder and moving the welding head radially above the terminal edge of the external jacket, the terminal edge of the spacer and the terminal edge of the cylindrical container,
f) moving the welding head around the longitudinal axis to weld the cap, the hollow cylindrical container, the spacer and the external jacket in a single step, and
h) machining the cap blank to remove welding residues resulting from the passage of the welding head to obtain the definitive cap.

In one particular embodiment of the foregoing method the radial shoulder can include a sacrificial terminal portion having a radial length such that after it is screwed into the hollow cylindrical container it radially overlies the external jacket by a particular length. In this case:
the step e) consists in rotating and moving the welding head so that the welding pin penetrates the radial terminal shoulder and is moved radially until the welding pin is located above the terminal edge of the external jacket, the terminal edge of the spacer and the terminal edge of the cylindrical container, and
the step h) includes removing the part radially overlying the external jacket.

In particular embodiments of the invention, when the radial shoulder includes a sacrificial terminal portion:
the method can include after the step c) and before the step e) a step d) consisting in placing the welding head axially above the sacrificial terminal portion,
the method can include after the step c) and before the step e) a step d) consisting in placing the welding head radially relative to the sacrificial terminal portion, and/or
the method can include after the step f) and before the step h) a step g) consisting in, once the welding head has executed a complete turn, centrifugal radial movement of the welding head toward the sacrificial terminal portion, preferably where the welding pin has been inserted, and moving the welding head to extract the welding pin from the radial shoulder.

Other features of the invention are set out in the following detailed description given with reference to the appended figures, provided by way of example, respectively representing:

FIG. 1 a diagrammatic view of a prior art stainless steel tank;

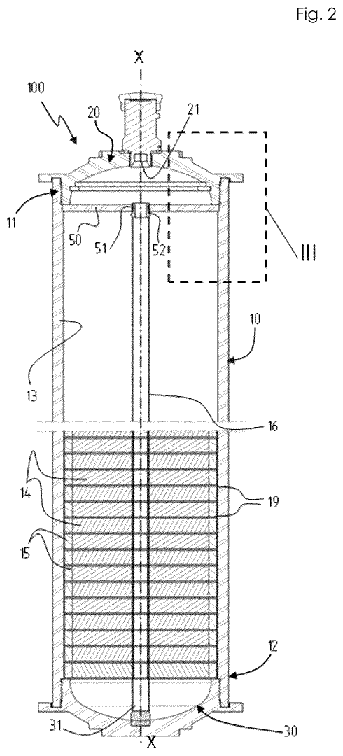

FIG. 2 a partial diagrammatic view in section of a first embodiment of a tank according to the invention including a tubular aluminium container closed by two caps before welding the caps;

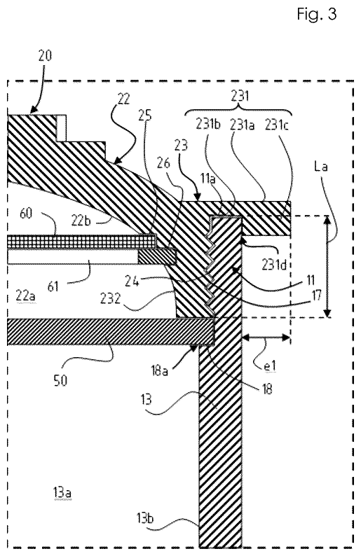

FIG. 3 a diagrammatic partial view in section to a larger scale of the upper part of the tank from FIG. 2 relative to the position depicted;

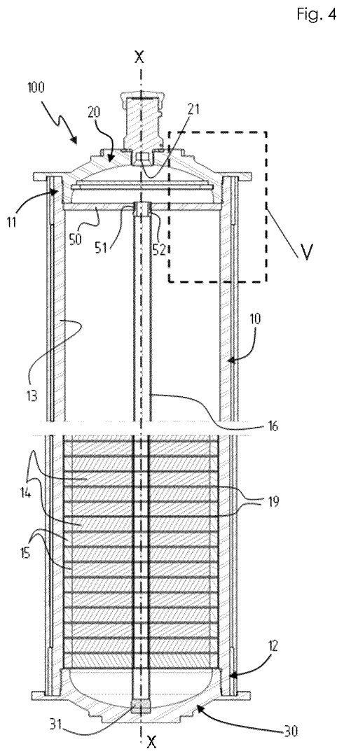

FIG. 4 a diagrammatic partial view in section of a second embodiment of a tank according to the invention including a tubular container, a spacer and a cylindrical external jacket closed by two caps before welding the caps;

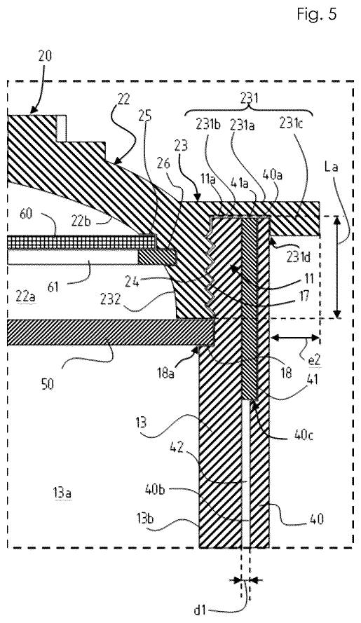

FIG. 5 a diagrammatic partial view in section to a larger scale of the upper part of the tank from FIG. 4 relative to the position depicted;

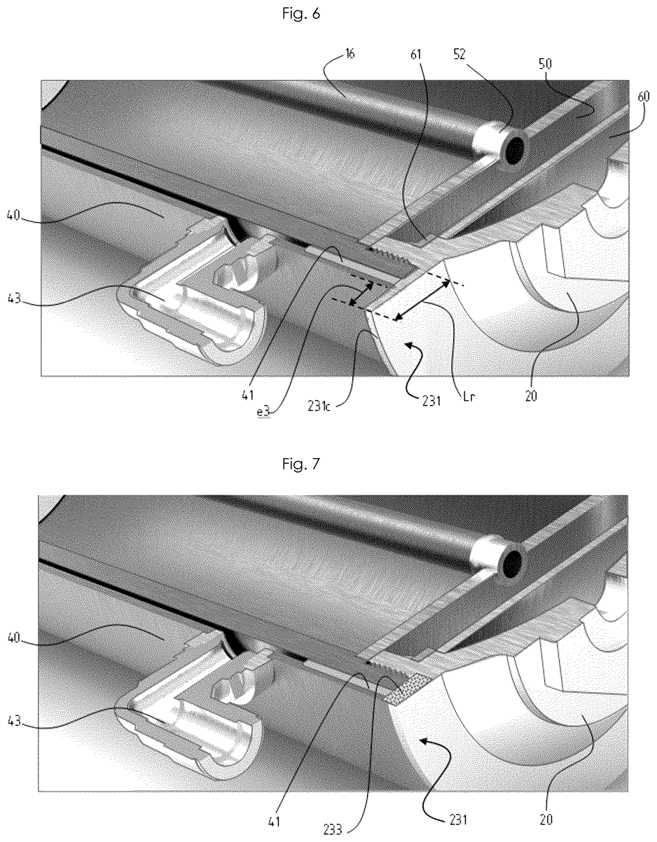

FIG. 6 a diagrammatic partial view in perspective and in section of a tank according to the invention before welding the cap;

FIG. 7 a diagrammatic view in perspective and in partial section of a tank according to the invention after welding the cap;

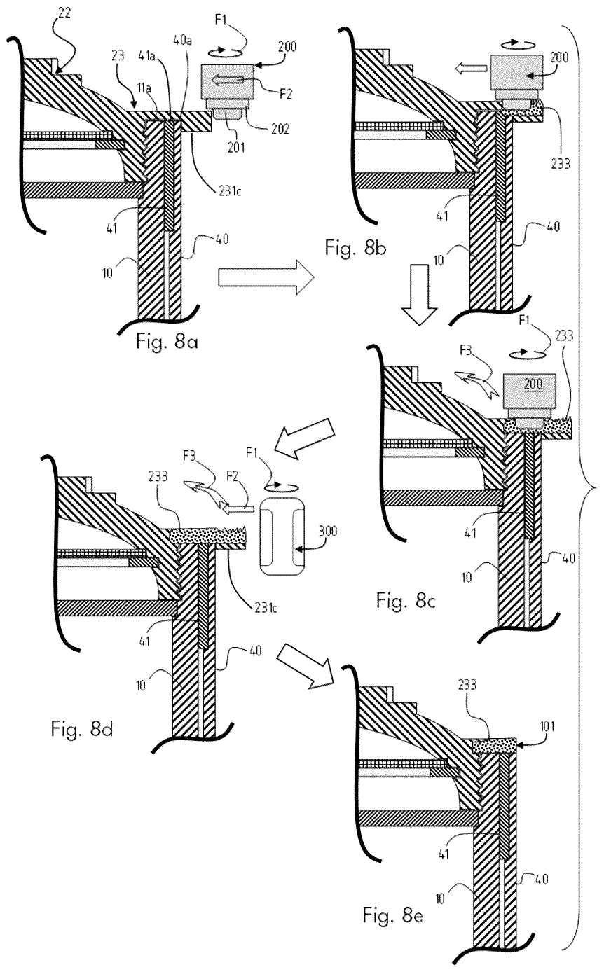

FIG. 8 a diagrammatic view in partial section of steps 8a to 8e of the method of manufacturing a tank in accordance with the invention; and

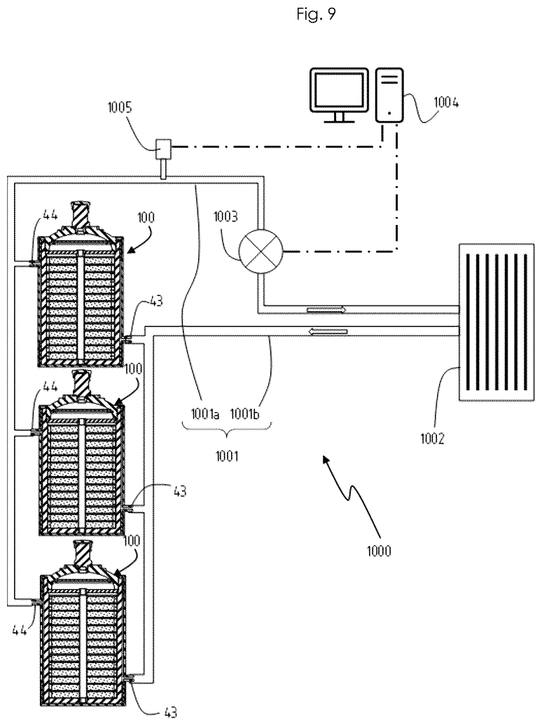

FIG. 9 a diagrammatic view of a system for storing hydrogen in solid form including tanks according to the invention and a circuit for thermal management of the tanks.

Elements common to the various figures are designated by the same references.

Generally speaking the hydrogen storage tank according to the invention, a first embodiment 1 of which is depicted in FIG. 2 and a second embodiment 100 of which is depicted in FIGS. 4 to 9, includes a hollow cylindrical container 10 extending along a longitudinal axis X-X. This axis can be vertical or horizontal in the position of use. In the remainder of the text the tank is described in a vertical position and so an element referred to as “upper” is at the top of the figure concerned and a lower element is at the bottom of the figure concerned.

Hereinafter an “axial” direction is a direction parallel to the axis X-X and a “radial” direction is a direction perpendicular to the axis X-X, that is to say in the direction of a radius passing through the axis X-X.

The hollow cylindrical container 10 has two ends 11 and 12 (with no neck) and is delimited by a thermally conductive cylindrical external radial wall 13 defining an interior volume 13a to receive, in use, at least one metal hydride for storing hydrogen in powder form or preferably in the form of compressed pellets 14. In the embodiment depicted these pellets 14 comprise a ring 15 of expanded natural graphite compacted in a uniaxial direction similar to those of the document FR2924787. Alternatively the pellets can consist of a mixture of metal hydrides and expanded natural graphite or merely of metal hydrides.

The hollow cylindrical container 10 also includes a passive hydrogen diffusion tube 16 extending axially in the metal hydride along the axis X-X along the hollow cylindrical container. This tube 16 acts as an interface between the gaseous hydrogen and the metal hydrides of the discs. Indeed, it is adapted to allow hydrogen to pass through it without allowing metal hydride to pass through it. It is fluidically connected to a hydrogen inlet/outlet orifice 21 in a first cap 20 for sealed closure of the first end 11 of the hollow cylindrical container 10.

In the two embodiments depicted in FIGS. 2 and 3 and 4 to 7 the two ends 11 and 12 are free and closed by blanks of caps to be fixed thereto by welding by the method in accordance with the invention described below and depicted in FIGS. 8a to 8e.

The second end 12 of the hollow cylindrical container is therefore free and closed by a second cap 30 similar to the first cap 20 for closing the first free end 11 except that it does not include a hydrogen inlet/outlet orifice but does include a means 31 for fixing the passive hydrogen diffusion tube 16. The other features being identical to those of the first end and the first cap, they are not described further. In the remainder of the description the first cap 20 is simply designated the “cap” except when there is explicit mention of the second cap. As explained below the cap or caps is/are in the form either of a cap blank, before welding, or in the form of a finished cap, after welding.

Alternatively the second end 12 of the hollow cylindrical container is not free but consists of a wall in one piece with the thermally conductive external radial wall 13 of the hollow cylindrical container 10. In this case only the cap 20 at the first end 11 has to be fixed by the method according to the invention.

By way of example the tanks 1 and 100 in FIGS. 2 and 4 depict an embodiment in which the two ends are closed by a cap blank 20-30 intended to be welded by the method of the invention.

The arrangement of the first embodiment of the invention is depicted to a larger scale in FIG. 3.

Thus in accordance with the invention the cap 20 comprises a central portion 22 that preferably carries the hydrogen inlet/outlet orifice 21 and a peripheral portion 23.

This peripheral portion 23 comprises a radial shoulder 231 (that is to say a shoulder perpendicular to the axis X-X) having a free external surface 231a and an interior surface 231 b intended to be in contact with the terminal edge 11a of the first end 11 of the hollow cylindrical container 10.

The structure of the cap and welding it to the hollow cylindrical container in the first embodiment are similar to what is described below with reference to the second embodiment from FIGS. 4 to 9.

These FIGS. 4 to 9 depict a second embodiment of a hydrogen storage tank the structure of which enables it to be manufactured from aluminium or aluminium alloy while enabling optimised management of thermal exchanges. In this second embodiment the storage tank 100 according to the invention further comprises a hollow cylindrical external jacket 40 arranged around the hollow cylindrical container 10. This external jacket is held at a distance d1 determined by at least one preferably cylindrical spacer 41 arranged near the first end 11 of the hollow cylindrical container 10 and the cylindrical external jacket 40 (here the first end of the jacket is the upper end). A sealed volume 42 for circulation in use of a heat transfer liquid is therefore defined between the external jacket 40 and the hollow cylindrical container 10.

The external jacket 40 advantageously has on an interior face 40b facing the cylindrical container 10 in the position of use a rabbet 40c intended to have the spacer 41 bear on it so that, during assembly, the upper edge 41a of the spacer is aligned with the upper edge 40a of the external jacket 40 and the upper edge 11a of the upper end 11 of the cylindrical container 10.

Furthermore, as FIGS. 6 and 7 show, the external jacket 40 includes an inlet 43 and an outlet 44 (see FIG. 9) for the heat transfer liquid in use.

By circulating the heat transfer liquid in the volume 42 during use of the tank 100 it is possible to recover heat coming from the hydrogen storage volume 13a through the wall 13 or to input heat to it in order to improve control and the duration of hydrogen storage/delivery.

This recovery of heat is possible because the wall 13 of the cylindrical container 10 is made of aluminium or aluminium alloy and therefore has an optimal thermal transfer capacity.

In order to enable the use of aluminium as the material constituting the cylindrical container 10 the invention firstly provides for all the parts constituting the jacket of the tank (the cylindrical container 10, the spacer 41, the external jacket 40 and the cap 20) are made of the same material based on aluminium, which enables identical reaction of the parts to subsequent steps of the method of manufacture according to the invention.

The invention thereafter provides a particular relative arrangement of these parts, as described hereinafter.

Finally the invention provides a welding method that enables welding of the four parts to one another (or in the first embodiment the two parts, namely the cap and the terminal edge of the hollow cylindrical container) in a single operation so that the weld prevents hydrogen from passing between the cap 20 and the terminal edge of the cylindrical container 10, the terminal edge of the spacer 41, and the terminal edge of the external jacket 40.

The arrangement of the second embodiment of the invention is depicted to a larger scale in FIGS. 5, 6 and 7.

As in the first embodiment the cap 20 includes a central portion 22 that preferably carries the hydrogen inlet/outlet orifice 21 and a peripheral portion 23.

This peripheral portion 23 includes a radial shoulder 231 (that is to say a shoulder perpendicular to the axis X-X) having a free external surface 231a and an interior surface 231b intended to be in contact with the terminal edge 11a of the first end 11 of the hollow cylindrical container 10, the terminal edge 41a of the spacer 41, and the terminal edge 40a of the cylindrical external jacket 40.

Furthermore the radial shoulder 231 of the cap includes, before the tank is manufactured, that is to say when the cap is in the blank state, a sacrificial terminal portion 231c having a radial length such that after screwing into the cylindrical container it radially overlies the hollow cylindrical container 10 by a particular length el in the first embodiment (see FIG. 3) and radially overlies the external jacket by a particular length e2 in the second embodiment (see FIG. 5).

The peripheral portion 23 moreover includes an axial shoulder 232 (that is to say a shoulder parallel to the axis X-X) extending in the direction of the hollow cylindrical container 10 and including a screwthread 24 intended to cooperate with a screwthread 17 carried by an internal face 13b of the first end 11 of the hollow cylindrical container 10.

In a preferred embodiment depicted in FIGS. 3 and 5 the sacrificial terminal portion 231c has a thickness such that the radial shoulder 231 has a groove 231d on its interior surface 231b between the sacrificial terminal portion 231c and the axial shoulder 232. This groove 231d is intended to receive and to cap the terminal edge 11a of the first end 11 of the hollow cylindrical container 10 in the first embodiment and the terminal edge 41a of the spacer 41 and the terminal edge 40a of the cylindrical external jacket 40 in the second embodiment, in order to hold them axially and radially during welding.

In an alternative embodiment depicted in FIG. 6 the sacrificial terminal portion 231c has a thickness identical to that of the rest of the radial shoulder 231 but a particular length e3 to enable the temperature of the aluminium to rise sufficiently by virtue of the action of the rotation of the welding pin.

What is important is that the thickness and the length of the sacrificial terminal portion 231c enable use of the method of manufacture according to the invention described with reference to FIG. 8.

In the first embodiment and in the second embodiment the central portion 22 of the cap 20 includes the hydrogen inlet/outlet orifice 21 fluidically connected to the passive hydrogen diffusion tube 16.

The invention does not necessitate a particular profile of the cap of this central portion 22, but in one particular advantageous embodiment the central part 22 nevertheless has an interior volume 22a delimited by an interior surface 22b. In a preferred embodiment the central part 22 is of convex shape but it could be of parallelepipedal shape. The interior surface 22b also extends along the axial shoulder 232.

In the preferred embodiment of the invention the internal face 13b of the hollow cylindrical container 10 includes under the screwthread 17 carried by the first end 11a peripheral rabbet 18 for sealed and forcible axial bearing on a disc seal 50 provided with a sealed passage opening 51 for one end of the passive diffusion tube 16. To this end an intermediate junction part 52 is advantageously provided between the disc seal 50 and the end of the passive diffusion tube 16, this junction piece 52 being designed to decouple the disc seal 50 and the passive diffusion tube 16 mechanically in a sealed manner.

To fix the disc seal 50 to the hollow cylindrical container 10 in sealed manner the axial shoulder 232 of the cap 20 preferably has an axial length La determined so that in the position of use an end of the axial shoulder 232 of the cap defines with the peripheral rabbet 18, bearing forcibly and axially on the disc seal 50, a radial and axial immobilisation groove 18a for axial and sealed immobilisation of the disc seal 50. A seal that can be crushed can advantageously be provided between the disc seal and the rabbet 18.

In other words the rabbet 18 is sized relative to the thickness of the disc seal 50 and the screwthread 17 so that in the position of use screwing on the cap 20 axially crushes the disc seal 50 against the peripheral rabbet 18, either directly or via a supplementary seal.

The disc seal 50 fixed in sealed manner into the hollow cylindrical container 10 at the level of the rabbet 18 enables retention of the hydrides (in powder form or in the form of pellets 14, 15) in the storage area 13a of the tank, in particular during swelling/shrinkage thereof at the time of absorption/desorption of hydrogen. Thanks to the axial shoulder 232 rigidly attached to the radial shoulder 231 welded to the hollow cylindrical container 10 the disc seal 50 cannot rise because of the effect of the swelling of the hydrides and the seal is ensured.

The disc seal 50 therefore prevents solid hydride particles being able to escape from the tank via the inlet-outlet orifice 21.

To favour homogeneous distribution of stress on the disc seal it is possible to provide elastic return means between the pellets 14, 15 and the disc 50 or an intermediate disc bearing against the disc 50.

The tank according to the invention further includes a safety device for preventing solid hydride particles escaping via the inlet-outlet orifice 21 that have escaped through the passive diffusion tube 16 or a break in the seal at the level of the disc seal. To this end the internal face 22b of the first cap 20 facing the interior of the hollow cylindrical container 10 includes a peripheral sheet 25 to bear axially and in a sealed manner on a passive hydrogen diffusion filter 60 adapted to allow hydrogen to pass through it without allowing metal hydride to pass through it. Under the peripheral rabbet 25 the internal face 22b of the first cap 20 also includes a peripheral groove 26 for axial and radial retention of an elastic means 61 for retaining the passive diffusion filter 60 against the rabbet 25. This elastic retaining means is advantageously a circular elastic fixing member such as a circlip.

The width of the circlip is such that the circlip forms with the peripheral rabbet 25a groove for clamping the filter 60 axially in sealed manner.

This embodiment advantageously utilises the preferred convex shape of the cap 20, enabling installation of the passive hydrogen diffusion filter 60 in a simple manner necessitating only a small height in the cap 20.

During manufacture the filter 60 and the circlip are fixed inside the cap 20. The hollow cylindrical container is filled with metal hydrides for storing hydrogen, either in the form of powder or in the form of compressed pellets 14, advantageously including expanded natural graphite (in a mixture or in the form of a peripheral ring), the pellets being separated by thermally conductive aluminium discs 19 adapted to transfer heat to the thermally conductive external radial wall 13.

The disc seal 50 is thereafter positioned so as to bear in the rabbet 18 of the hollow cylindrical container 10.

In the second embodiment of the tank 100 according to the invention the hollow cylindrical container 10 fitted with the disc seal 50 is then disposed in the external jacket 40 and the spacer 41 is placed between the cylindrical container 10 and the external jacket 40 until it rests on the bottom of the peripheral rabbet 40c. In this position the cylindrical spacer and the first terminal edge of the external jacket are aligned, which is to say that the upper edge 11a of the cylindrical container 10, the upper edge 41a of the spacer 41, and the upper edge 40a of the external jacket 40 are coplanar.

The cap 20 in its blank form is then screwed onto the internal face 13b of the cylindrical container 10 by cooperation of the screwthreads 17 of the container 10 and 24 of the cap 20.

In the first embodiment the interior surface 231b of the radial shoulder 231 is then in contact with the terminal edge 11a of the first end 11 of the hollow cylindrical container 10. In this case the sacrificial terminal portion 231c radially overlies the hollow cylindrical container 10.

In the second embodiment the interior surface 231b of the radial shoulder 231 is in contact with the terminal edge 11a of the first end 11 of the hollow cylindrical container 10, the terminal edge 41a of the spacer 41, and the terminal edge 40a of the cylindrical external jacket 40. In this case the sacrificial terminal portion 231c radially overlies the external jacket 40.

The same operation is repeated if the second end of the tank must also be closed by a cap.

The cylindrical container 10, the external jacket 40, the spacer 41 and the peripheral portion 23 of the cap are then friction stir welded together. The combination of a particular embodiment of friction stir welding and the foregoing arrangement of the constituent parts of the tank according to the invention enable fixing in a hermetically sealed manner of these various parts in one operation, which ensures the cohesion of the assembly and eliminates all risk of gaseous hydrogen leaking through this junction zone between the cap and the body of the tank.

The preferred embodiment of the friction stir welding process for the tank 100 depicted in FIG. 8 is described next. This process is depicted with a tank 100 according to the second embodiment of the invention but is identical for the tank 1 according to the first embodiment without the external jacket and the spacer.

The objective is to weld in a single operation four distinct parts (or two distinct parts in the first embodiment): the peripheral portion 23 of the cap 20, and more particularly the radial shoulder 231, the cylindrical container 10, the spacer 41 and the external jacket 40.

The welding process used is the friction stir welding (FSW) process applied in a single cycle, although the latter cycle comprises a plurality of sub-steps (penetration, radial movement, peripheral rotation, withdrawal). This cycle assures in a single continuous thermal operation the homogeneous welding of the parts constituting the jacket of the tank. Thanks to the high thermal conductivity of aluminium a bead of softened material is formed at the level of the radial terminal shoulder of the cap, simultaneously covering the edge surfaces of the parts to be assembled (cylindrical container, spacer, external jacket), ensuring homogeneous fusion with no point of weakness and without necessitating repositioning or interruption of the welding cycle.

To this end the assembly is placed in a friction stir welding (FSW) machine adapted to allow movement in translation and movement in rotation between a welding head 200 of the machine and the tank 100 to be welded.

The welding head 200 is provided with a welding pin 201 and preferably a planishing shoulder 202.

When all the parts of the tank have been fixed into the machine the welding head is rotated at high speed in the direction of the arrow F1 and the welding head is moved so that the welding pin comes into radial or axial contact with the sacrificial terminal portion 231c of the radial terminal shoulder 231. In FIG. 8a the pin 201 of the welding head 200 is depicted as entering radially into the sacrificial terminal portion 231c but the pin 201 of the welding head 200 could enter it axially. In this case the method includes a step consisting in placing the welding head 200 axially above the sacrificial terminal portion 231c so that the welding pin 201 penetrates the sacrificial terminal portion 231c axially, that is to say from above.

The rotation at high speed and the radial pressure applied to the welding head 200 generate localised heating such that the aluminium or the aluminium alloy constituting the sacrificial terminal portion 231c is softened.

Once this state has been obtained the welding head 200 is moved radially in the direction of the arrow F2 so that the welding pin 201 is moved centripetally in the direction of the central part 22 of the cap 20, above the terminal edge 40a of the external jacket 40, the terminal edge 41a of the spacer 41, and the terminal edge 11a of the cylindrical container 10 (FIGS. 8b and 8c). The welding head 200 is arranged axially in the radial terminal shoulder 231 at a depth sufficient for the welding pin to reach the upper edge of the cylindrical container, the upper edge of the cylindrical external jacket, and the upper edge of the cylindrical spacer under the thickness of the cap. Throughout the duration of welding the welding pin 201 is preferably driven axially approximately 1 mm to 2 mm into the upper edge of the cylindrical container, the upper edge of the cylindrical external jacket, and the upper edge of the cylindrical spacer, passing through the radial terminal shoulder 231.

The excellent thermal conduction of aluminium also leads to softening of the aluminium of an upper part of the external jacket 40, the spacer 41 and the cylindrical container 10 so that a bead 233 of softened aluminium is formed all around the welding pin 201 in the radial terminal shoulder 231, covering and comprising the terminal edge 40a of the external jacket 40, the terminal edge 41a of the spacer 41, and the terminal edge 11a of the cylindrical container 10.

Once the pin 201 of the welding head 200 has passed the junction between the spacer 41 and the cylindrical container 10 the welding head is moved in the direction of the arrow F3 all around the longitudinal axis X-X of the tank to form a peripheral cordon 233 of softened material closed on itself. Consequently it is necessary to adapt the diameter of the welding pin to be sure that, when rotating, it covers all the junctions between the terminal edges of the parts.

Once the welding head 200 has effected a complete turn the welding head 200 is moved radially and centrifugally toward and in the sacrificial terminal portion 231c, preferably at the location where the welding pin has been inserted, and the welding head 200 is moved to cause the welding pin 201 to exit the radial shoulder 231 of the cap 20. Causing the welding pin 201 to exit laterally relative to the circular weld bead ensures a homogeneous weld between the peripheral portion 23 of the cap 20, the terminal edge of the hollow cylindrical container 10, the terminal edge of the spacer 41, and the terminal edge of the external jacket 40. This offsets the exit point of the pin, which has a non-homogenous structure, into a part of the cap to be removed afterwards.

Accordingly, when the bead 233 of softened material cools the external jacket 40, the spacer 41, the cylindrical container 10 and the peripheral portion 23 of the cap 20 are welded together in a single step, forming one part where they are joined. The invention therefore makes it possible, with a single weld, to produce the seal against hydrogen (the weld between the cylindrical container 10 and the peripheral portion 23 of the cap 20) and, in the second embodiment, the seal against the heat transfer liquid (for example water; the weld between the external jacket 40, the spacer 41 and the peripheral portion 23 of the cap 20). In other words a single weld enables a seal to be provided between two different circuits: that of hydrogen and that of the heat transfer liquid.

In the preferred embodiment of the method the material used to enable the rise in pressure and temperature at the level of the coaxial pin consists in an extension of the peripheral portion of the cap: the sacrificial terminal portion 231c of the radial terminal shoulder 231.

This sacrificial portion advantageously comprises an extra thickness forming a groove 231d to receive the terminal edge of the external jacket 40, the spacer 41 and the hollow cylindrical container 10. This enables perfect retention of the parts to one another radially and axially against the cover throughout welding. Indeed it is important for the radial space between the external jacket 40, the spacer 41 and the hollow cylindrical container 10 to be as small as possible, because the originality of the welding enabled by the structure of the tank according to the invention stems from the fact that the welding head moves above and at the level of edge surfaces of parts and not at the level of lateral edges of parts. Now the friction stir welding process requires not only a high rotation speed to reach the necessary temperature but also a very high vertical and lateral force to move the welding head.

The arrangement according to the invention includes welding these edges of parts through the cap which at the same time holds said parts one against the other. Without wishing to be restricted by theory, the radial shoulder 231 of the cap enables homogeneous distribution of the vertical stress on the welding head and prevents the latter from descending too low. Similarly the radial retention of the parts together or even simply the radial retention of the hollow cylindrical container 10 in the first embodiment prevents the parts from buckling vertically and moving away from one another, so that the reaction of the parts to vertical and radial stress is maintained. This prevents the welding head from suddenly dropping if two parts were to be moved apart and allow the welding head to drop.

In other words the originality of the welding method according to the invention relies on the arrangement of the various parts of the tank 1, 100 according to the invention by proposing friction stir welding through a first part (the cap 20) of the terminal edge of one or three parts (the hollow cylindrical container 10, the spacer 41 and the external jacket 40) arranged perpendicularly to the first part in order to weld two or four parts in a single step. The stress applied by the welding head is therefore applied via one part and facing the edges of the other parts, whereas this type of welding is usually effected directly between two parts, perpendicularly to the edges of said parts that adjoin one another.

Radial retention of the parts is advantageously obtained by the groove 231d of the radial shoulder 231 but can equally be obtained by the frame of the welding machine against which the tank is held during the welding process.

The length e1 between the edge of the hollow cylindrical container 10 and the end of said extension or the length e2 between the edge of the external jacket and the end of this extension is such that the temperature and pressure conditions at the level of the coaxial pin after travelling this length el or e2 corresponds to that necessary to weld the elements to be welded.

The length e1 or e2 is determined as a function of the thickness of the radial terminal shoulder 231 (and in particular of the sacrificial terminal part 231c) and its composition so that after travelling this length e the rotating welding pin reaches by friction a temperature softening the aluminium or aluminium alloy constituting the cap, the cylindrical container, the spacer and the external jacket sufficiently for the material to be softened, not melted.

The extra thickness of the sacrificial terminal part therefore enables the aluminium to withstand the stress of the welding pin with no risk to the remaining parts of the tank and to rise sufficiently in temperature to form a softened bead 233 that extends slightly upstream of the welding pin thanks to the thermal conductivity of aluminium and therefore with no risk of deformation of the parts.

Alternatively the sacrificial portion can have a particular length that allows this rise in temperature before arriving above the parts to be welded.

The aligned arrangement of the three terminal edges under the radial portion is particularly suitable for friction stir welding (FSW) and enables a seal to be made between the cap and the hydrogen storage volume in a single welding step through the cap thanks to the thermal conductivity of the aluminium used, in a perfectly homogeneous manner because the weld bead 233 consists of material of the four parts, with no risk of cracking or deformation.

The mobile welding head preferably includes a planishing shoulder 202 above the welding pin 201. In this case the welding pin has a length determined so that the welding head can be placed so that the planishing shoulder is against the weld bead 233 when the welding head moves and flattens it.

When the process entails radial penetration of the welding head into the sacrificial terminal part 231c the method includes radial placement of the welding head relative to the peripheral portion of the cap so that the planishing shoulder 202 of the welding head is flush with the free surface of the radial terminal shoulder 231.

Following the peripheral welding the cap blank is machined to remove welding residues resulting from the passage of the tool head and to shape the cap.

As FIGS. 8d and 8e show by way of non-limiting example the portion 231c radially overlying the external jacket 40 is removed by a milling machine 300. The end result is a finished hydrogen tank the finished lateral rim 101 of which consists of one and only one aluminium part. In FIGS. 5 and 6 the weld bead 233 is indicated by a dashed line frame to distinguish it from the parts 10, 40 and 41 seen in section and by an oblique line frame, but the bead 233, being formed by material resulting from friction stir welding of the material of all these parts, in reality cannot be distinguished visually from the rest of the parts and in particular from the external jacket 40 and the cap 20.

In another embodiment the tank 100 has two caps, one at each end of the hollow cylindrical container 10 and the external jacket 40.

The second cap 30 can be identical to the first cap 20 or not include some parts of the first cap 20, such as for example the hydrogen entry/exit orifice 21 and consequently the disc seal 50 and the passive hydrogen diffusion filter 60.

In this embodiment the second cap 30 is friction stir welded to the second terminal edge of the hollow cylindrical container 10, a second cylindrical spacer, and the cylindrical external jacket 40 in the peripheral part of the second cap 30.

This welding also produces a sealed volume 42 between the cylindrical container 10 and the external jacket 40 adapted to enable circulation of a heat transfer fluid around and in contact with the cylindrical container containing the metal hydrides.

The absorption of hydrogen by the hydrides is an exothermic process; it gives off heat. The desorption of hydrogen from the hydrides is an endothermic process and therefore results in cooling.

The transfer fluid in contact with the cylindrical container 10 transfers thermal energy given out or taken in because of the reactions of absorption/desorption of the hydrides with hydrogen transmitted through the wall 13 of the cylindrical container 10. The heat transfer fluid is then evacuated via the outlet 44 and provides a high level of thermal transfer between the interior and the exterior of the tank.

As FIG. 9 shows the finished hydrogen tank 100 can then be integrated into a system 1000 for storing hydrogen in solid form comprising one or advantageously more tanks 100 according to the invention for storing hydrogen in solid form.

It also includes a circuit 1001 for circulating a heat transfer fluid connected on the one hand to the heat transfer liquid inlet 43 and outlet 44 of the external jacket of the or each tank 100 and on the other hand to a heat exchanger 1002 adapted to cool/heat the heat transfer fluid, and a means 1003 (such as a pump) for circulating the heat transfer fluid in the circuit 1001 between the hydrogen storage tank(s) 100 and the heat exchanger 1002.

The circulation means 1003 is advantageously controlled by a central unit 1004 connected to one or more temperature sensors 1005. In FIG. 9 a temperature sensor 1005 is arranged in the circulation circuit 1001a connecting the outlets 44 of the tanks to the heat exchanger 1002 but could be situated in the circuit 1001b connecting the inlets 43 of the tanks or in the heat exchanger 1002 itself. This sensor or these sensors could equally equip directly the inlets 43/outlets 44 of the tanks 100.

It is therefore possible to control the circulation of the heat transfer fluid to manage the heating or cooling produced in such a manner as to accelerate the absorption and desorption of hydrogen. It is possible to connect an auxiliary circuit (not depicted) to the outlet of the heat exchanger 1002 to use the heating or cooling generated in the tank outside the system, for example to cool a motor or the air in an air conditioning circuit.

This second embodiment with the external jacket 40 is particularly advantageous for applications necessitating rapid storage and delivery of hydrogen. Indeed, in this case the evacuation and the input of heat must also be rapid and the most effective way to achieve this is to evacuate and to input heat by means of a heat transfer liquid.

Alternatively applications generating slow storage/delivery have less need for rapid evacuation/input of heat, with the result that use of the tanks 1 according to the first embodiment with no external jacket 40 suffices. In this case a simple system for circulating air around the tanks 1 can suffice. A fan can suffice but a system for introduction of air into and removal of air from the compartment housing the hydrogen storage reservoir 1 is preferable in order to renew the air and to evacuate or input heat.

The invention enables design and manufacture of hydrogen tanks that are compact, light in weight (because the greater part of their wall is thin), modular, safe (that is to say with no risk of the wall rupturing because of mechanical stresses and no risk of explosion) and of improved energy efficiency (that is to say enabling faster absorption/desorption) thanks to optimal thermal transfer made possible by the specific structure of the tank allowing the use of aluminium as the constituent material.

1. Tank (1, 100) for storing hydrogen in solid form, comprising:
a hollow cylindrical container (10) extending along a longitudinal axis (X-X), having a first end (11) and a second end (12), and delimited by a thermally conductive exterior radial wall (13), the hollow cylindrical container (10) comprising:
at least one metal hydride for storing hydrogen, and
a tube (16) for passive diffusion of hydrogen extending axially along the hollow cylindrical container (10) inside the metal hydride and adapted to allow hydrogen to pass through it without allowing metal hydride to pass through it, and
a first cap (20) for closing and sealing the first end (11) of the hollow cylindrical container (10), the first cap (20) including a hydrogen inlet/outlet orifice (21) fluidically connected to the passive hydrogen diffusion tube (16), which tank is characterized in that:
the first cap (20) comprises a central portion (22) and a peripheral portion (23), the latter including:
a radial terminal shoulder (231) including a free surface (231a) opposite a welding surface (231b) shaped to be able to be in contact with a first terminal edge (11a) of the first end (11) of the hollow cylindrical container (10),
an axial shoulder (232) extending axially in the direction of the hollow cylindrical container (10) and including a screwthread (24) intended to cooperate with a screwthread (17) carried by an internal face (13b) of the first end (11) of the hollow cylindrical container (10),
the hollow cylindrical container (10) and the cap (20) are made of the same material, aluminium or aluminium alloy, and
the first cap (20) is welded to the first terminal edge (11a) of the hollow cylindrical container (10) by friction stir welding (FSW) in the peripheral portion (23) of the cap (20).

2. Tank (100) according to claim 1 in which the interior wall (13b) of the hollow cylindrical container (10) includes, under the screwthread (17) carried by the first end (11) a peripheral rabbet (18) on which bears a disc seal (50) including an opening (51) for the sealed passage of one end of the passive diffusion tube (16).

3. Tank (100) according to claim 2 in which the axial shoulder (232) of the cap (20) has an axial length (La) determined so that in the position of use one end of the axial shoulder (232) of the cap defines with the peripheral rabbet (18) on which the disc seal bears a groove (18a) for immobilising the disc seal (50) radially and axially.

4. Tank (100) according to claim 2 including an intermediate junction part (52) between the disc seal (50) and the end of the passive diffusion tube (16).

5. Tank (100) according to claim 1 in which an internal face (22b) of the first cap (20) directed toward the interior of the hollow cylindrical container (10) includes a peripheral rabbet (25) on which bears in sealed manner a passive hydrogen diffusion filter (60) adapted to allow hydrogen to pass through it without allowing metal hydride to pass through it, and a peripheral groove (26) for axially and radially fixing an elastic means (61) for holding the passive diffusion filter (60) against the peripheral rabbet (25).

6. Tank (100) according to claim 1 in which:
the storage tank (100) further includes a hollow cylindrical external jacket (40) arranged around the hollow cylindrical container (10) at a distance (d1) determined by at least one cylindrical spacer (41) arranged near the first end (11) of the hollow cylindrical container (10) and the cylindrical external jacket (40) in such a manner as to define between the external jacket (40) and the hollow cylindrical container (10) a sealed volume (42) for circulation in use of a heat transfer liquid, the external jacket (40) including an inlet (43) and an outlet (44) for the heat transfer liquid in use,
the free surface (231a) of the radial terminal shoulder (231) is shaped so that it can be in contact with the first terminal edge (11a) of the first end (11) of the hollow cylindrical container (10), a first terminal edge (41a) of the cylindrical spacer (41), and a first terminal edge (40a) of the cylindrical external jacket (40),
the hollow cylindrical container (10), the cylindrical external jacket (40), the cylindrical spacer (41) and the cap (20) are made of the same material, aluminium or aluminium alloy, and
the first cap (20) is welded to the first terminal edge (11a) of the hollow cylindrical container (10), to the first terminal edge (41a) of the cylindrical spacer (41) and to the first terminal edge (40a) of the cylindrical external jacket (40) by friction stir welding (FSW) in the peripheral portion (23) of the cap (20).

7. Tank (1, 100) according to claim 1 in which:
the second end (12) of the hollow cylindrical container (10) is closed by a wall forming an integral part of said container (10).

8. Tank (1, 100) according to claim 1 in which:
the second end (12) of the hollow cylindrical container (10) has a structure identical to that of the first end (11) of said container and is welded to a second cap (30) in an identical manner to welding said first end (11) to the first cap (20).

9. System (1000) for storing hydrogen in solid form characterized in that it includes:
at least one tank (100) according to claim 6 for storing hydrogen in solid form,
a circuit (1001, 1001a, 1001b) for circulating a heat transfer fluid connected on the one hand to the heat transfer liquid inlet (43) and outlet (44) of the external jacket (40) of the or each tank (100) and on the other hand to a heat exchanger (1002) adapted to cool/heat the heat transfer fluid, and
a means (1003) for circulating the heat transfer fluid in the circuit (1001) between the hydrogen storage tank(s) and the heat exchanger.

10. Method of manufacturing a tank (100) according to claim 1 for storing hydrogen in solid form characterized in that it comprises the following steps:
a) positioning the hollow cylindrical container (10) so that the first terminal edge (11a) of the hollow cylindrical container (10) is ready to receive a cap (20) blank including a radial terminal shoulder (231),
b) screwing the cover (20) blank into the screwthread (17) at the first end (11) of the cylindrical container (10),
c) placing the whole in a friction stir welding (FSW) machine including a mobile welding head (200) with a welding pin (201) and preferably a planishing shoulder (202),
e) rotating the welding head (200) so that the welding pin (201) penetrates the radial terminal shoulder (231) and moving the welding head (200) radially above the terminal edge (11a) of the cylindrical container (10),
f) commanding movement of the welding head (200) around the longitudinal axis (X-X) to weld the cap (20) and the hollow cylindrical container (10) in a single step, and
h) machining the cap blank to remove welding residues resulting from the passage of the welding head and to obtain the definitive cap.

11. Method of manufacture according to claim 10 in which the radial shoulder (231) includes a sacrificial terminal portion (231c) having a radial length such that after being screwed into the hollow cylindrical container (10) it radially overlies the hollow cylindrical container (10) over a particular length (e1) and in which:
the step e) consists in rotating and moving the welding head (200) so that the welding pin (201) penetrates the radial terminal shoulder (231) and moves radially until the welding pin (201) is located above the terminal edge (11a) of the cylindrical container (10), and
the step h) includes removing the part (231c) radially overlying the hollow cylindrical container (10).

12. Method of manufacturing a tank (1) according to claim 6 for storing hydrogen in solid form characterized in that it comprises the following steps:
a) disposing the hollow cylindrical container (10) in the external jacket (40) and placing the spacer (41) between the cylindrical container (10) and the external jacket (40) so that the first terminal edge (11a) of the hollow cylindrical container (10), the first terminal edge (41a) of the cylindrical spacer and the first terminal edge (40a) of the external jacket (40) are coplanar,
b) screwing a blank of the cap (20) into the screwthread (17) at the first end (11) of the cylindrical container (10), the cap (20) blank including a radial terminal shoulder (231),
c) placing the whole in a friction stir welding (FSW) machine including a mobile welding head (200) with a welding pin (201) and preferably a planishing shoulder (202),
e) rotating the welding head (200) so that the welding pin (201) penetrates the radial terminal shoulder (231) and moving the welding head (200) radially above the terminal edge (40a) of the external jacket (40), the terminal edge (41a) of the spacer (41) and the terminal edge (11a) of the cylindrical container (10),
f) moving the welding head (200) around the longitudinal axis (X-X) to weld the cap (20), the hollow cylindrical container (10), the spacer (41) and the external jacket (40) in a single step, and
h) machining the cap blank to remove welding residues resulting from the passage of the welding head to obtain the definitive cap.

13. Method of manufacture according to claim 12 in which the radial shoulder (231) includes a sacrificial terminal portion (231c) having a radial length such that after it is screwed into the hollow cylindrical container (10) it radially overlies the external jacket (40) by a particular length (e2) and in which:
the step e) consists in rotating and moving the welding head (200) so that the welding pin (201) penetrates the radial terminal shoulder (231) and is moved radially until the welding pin (201) is located above the terminal edge (40a) of the external jacket (40), the terminal edge (41a) of the spacer (41) and the terminal edge (11a) of the cylindrical container (10), and
the step h) includes removing the part (231c) radially overlying the external jacket (40).

14. Method of manufacture according to claim 11 including after the step c) and before the step e) a step d1) consisting in placing the welding head (200) axially above the sacrificial terminal portion (231c).

15. Method of manufacture according to claim 11 including after the step c) and before the step e) a step d2) consisting in placing the welding head (200) radially relative to the sacrificial terminal portion (231c).

16. Method of manufacture according to claim 11 including after the step f) and before the step h) a step g) consisting in, once the welding head (200) has executed a complete turn, centrifugal radial movement of the welding head (200) toward the sacrificial terminal portion (231c), preferably where the welding pin has been inserted, and moving the welding head (200) to extract the welding pin (201) from the radial shoulder (231).

17. Tank (1, 100) according to claim 6, wherein the second end of the cylindrical external jacket (40) is also closed by a wall forming an integral part of said jacket (40).

18. Tank (1, 100) according to claim 6, wherein the second end of the cylindrical external jacket (40) has a structure identical to that of the first end of said jacket and is welded to said second cap (30) in a manner identical to welding said first end to the first cap (20).
